(19) United States
(12) Patent Application Publication
(10) Pub. No.: US 2008/0022771 A1
(43) Pub. Date: Jan. 31, 2008

(54) MICROMECHANICAL COMPONENT

(76) Inventors: Alexander Wolter, Dresden (DE); Harald Schenk, Dresden (DE)

Correspondence Address: BARNES & THORNBURG LLP, 11 SOUTH MERIDIAN, INDIANAPOLIS, IN, 46204, US

(21) Appl. No.: 11/782,355

(22) Filed: Jul. 24, 2007

(30) Foreign Application Priority Data
Jul. 28, 2006 (DE) DE 10 2006 036 49

(51) Int. Cl. G01P 15/02

(52) U.S. Cl. 73/514.38

(57) ABSTRACT

The invention relates to micromechanical components whose operating stability is increased with respect to known solutions. It can be a matter of sensors or also actuators in which a deflectable element can be deflected in at least one dimension.

It is the object of the invention to provide micromechanical components which achieve an increased operating stability, in particular with increased electrical voltages and other external disturbances. In components in accordance with the invention, a deflectable element having at least one spring is held at a frame part. The deflectable element is electrically separated from the frame part by grooves and an electrical insulation. An electrical voltage can be applied between the deflectable element and the frame part for the deflection. Path limitation elements are moreover present between regions which are at the same electrical voltage potential or where a negligible current flow occurs on a touching contacting of such regions.

The invention relates to micromechanical components whose operating stability is increased with respect to known solutions. It can be a matter of sensors or also actuators in which a deflectable element can be deflected in at least one dimension. It can be a translatory movement, a tilting or a pivoting around an axis of rotation.

The drive of this movement is as a rule based on the effect of electrostatic forces.

Substantial parts of such micromechanical components are manufactured from a substrate by structuring of the substrate. In this connection, starting from a surface, grooves are formed in the substrate which can extend through the total thickness on the finished component and can form continuous grooves.

Deflectable elements, which are held by springs, a frame part and, optionally, further elements such as electrode fingers can be formed by such a structuring.

An actuator is thus described in EP 1 123 526 B1 for the continuous deflection of electromagnetic radiation, which in particular relates to the drive of the actuator.

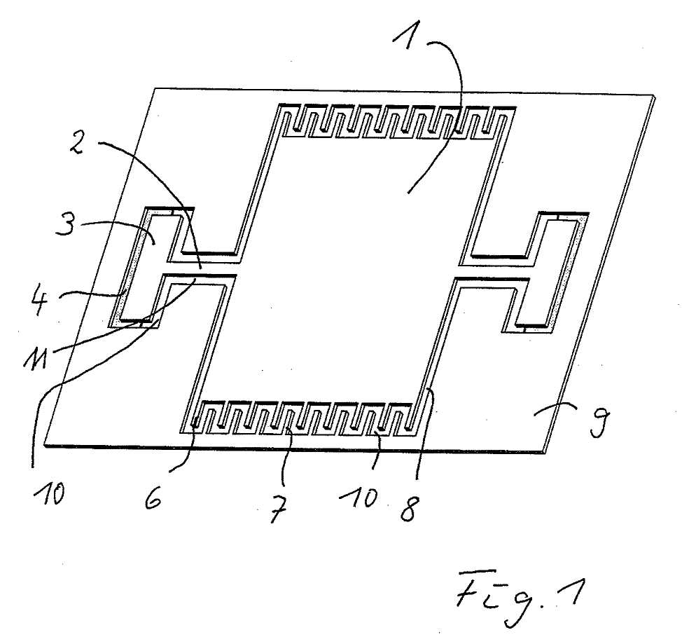

As already addressed, electrode fingers can thus be formed at a deflectable element and at a frame part and are arranged alternately in a mutually engaging manner and are made in comb form. The forces acting on the deflection of the element can thereby be increased. Such an embodiment is shown in FIG. 1.

In particular the filigree design of such micromechanical components, however, causes problems which impair the functionality and even the destruction of components can occur.

The frame part and the deflectable element have different electrical voltage potentials applied to them for the deflection. They therefore have to be electrically insulated from one another. On improper use, it can, however, occur that the electrical voltage difference is selected to be too large and regions or parts having different electrical voltage potentials thereby come into touching contact with one another, which results in electrical short-circuit with the known disadvantageous consequences.

Such a contact can also occur due to mechanical causes in that high mechanical accelerations act on a micromechanical component.

Destructive or damaging actions can thereby also be caused at parts such as in particular electrode fingers in the switched off state.

Parts of micromechanical components can, however, also adhere to one another, which is also called “sticking”. As a result, electrical short-circuits can likewise occur.

It is therefore the object of the invention to provide micromechanical components which achieve an increased operating stability, in particular with increased electrical voltages and other extreme disturbances.

This object is satisfied in accordance with the invention by a micromechanical component having the features of claim 1.

Advantageous aspects and further developments of the invention can be achieved using features designated in the subordinate claims.

Starting from the known micromechanical components, a deflectable element is held at a frame part by means of at least one spring. The spring can be a bending beam or a torsion spring depending on the application.

More frequently, however, at least two such springs are used which are arranged on a common axis and mutually opposite at the deflectable element.

The frame part of a component is electrically insulated with respect to further parts so that an electrical voltage potential can be connected to the frame part and an electrical voltage potential differing therefrom can also be connected at least to the deflectable element.

A deflection of an element can thus also be initiated as a result of active electrostatic forces, as also described in EP 1 123 526 B1.

The individual parts can be formed as the result of a structuring by means of grooves which are guided over the total thickness and their respective function can thus be achieved.

This produces a mechanical separation and also an electrical insulation of the parts acted on by the different electrical voltage potentials.

The electrical insulation can regionally also additionally be achieved by means of insulation. In this connection, grooves are filled at least partially or regionally with an electrically insulating material.

In accordance with the invention, in a preferred embodiment, however, path limitation elements are formed between regions which have the same electrical voltage potential applied. These path limitation elements prevent a movement of the deflectable element which could result in an unwanted direct contact of parts/regions of the component with electrical voltages differing from one another or could cause mechanical destruction by forces acting as a result of higher accelerations.

Path limitation elements should be designed, arranged and dimensioned such that a welding of contact surfaces can be avoided on a contact which might occur. In this connection, on a touching contact at path limitation elements, the remaining spacing at other areas (of e.g. electrode fingers, a deflectable element) should remain so large that no electrical flashover can occur either.

The possibility also exists, however, of providing path limitation elements at regions which have different electrical voltage potentials. Then, however, only a negligible electrical current flow should occur which cannot cause any damage to the component if the respective regions have approached each other so much that a touching contact has occurred. The electrical current flow over such a contact can be restricted by a high-ohm electrical connection such that no material degradation and in particular no welding of the touching parts can occur due to an electrical current flow which might occur. To achieve a high electrical resistance, such regions can be formed with a low-doped material. This can be a part at the frame. A suitable layer, e.g. made of polysilicon or undoped silicon in a structured form, can, however, also be formed.

For a high-ohm connection, the respective contact surfaces resulting from the side walls of the mutually oppositely disposed walls can be covered locally by a thin layer of poor or no electrical conductivity, by a material of no electrical conductivity or by a material with a very high electrical resistance (e.g. silicon oxide or silicon nitride).

The path limitation elements can preferably be formed with grooves which have a smaller clearance than other grooves formed between the deflectable element and the frame part. These grooves can therefore be narrower than other grooves. On a non permitted movement, only parts of a component can thus abut one another which have the same electrical voltage potential and are also mechanically more stable as a rule.

In this connection, the arrangement and alignment of such grooves for path limitation elements can be selected such that a limitation of movements is possible in one or also in a plurality of axial directions.

For instance, grooves with which path limitation elements are formed can be aligned in an axial direction at right angles to a direction in which the path limitation should be achieved. A plurality of such grooves can also be aligned at a right angle to one another or at an obliquely inclined angle with respect to the longitudinal axis of springs. A path limitation in a plurality of axial directions can be realized using the two last named alternatives.

The invention can also be used in embodiments of micromechanical components with electrode fingers. In this connection, the grooves should likewise have a larger clearance in the region in which electrode fingers are present at the deflectable element and frame part.

However, an electrically insulated additional armature can also preferably be arranged in this region, preferably at the frame part. It can then form a path limitation element with an abutment formed at the deflectable element. A smaller clearance should also be observed at least in one axial direction between the additional armature and the abutment than is the case with other grooves. It can thus be prevented that electrode fingers from the deflectable element and the frame part abut one another.

Grooves with which path limitation elements are formed can also be arranged in a plurality of axes whose spacing from longitudinal axes of one or springs is different. In this connection, the clearance of these grooves can be larger as the spacing from longitudinal axes increases than in such grooves arranged closer thereto.

This reduction in clearance can be selected to be step-wise.

Grooves of path limitation elements can, however, also be formed such that their clearance is only sufficiently small when the respective deflectable element has covered a specific path on an unwanted movement or when a tilt around a specific angle has occurred with respect to the component plane.

This can also be similarly effective for the path limitation with different, unwanted movements/deflection states of the deflectable element with an effect taking account of the respective movement/deflection of individual grooves or also a plurality of grooves which take these into account. Such grooves can thus only have a smaller clearance than other grooves of the component when such a state has occurred.

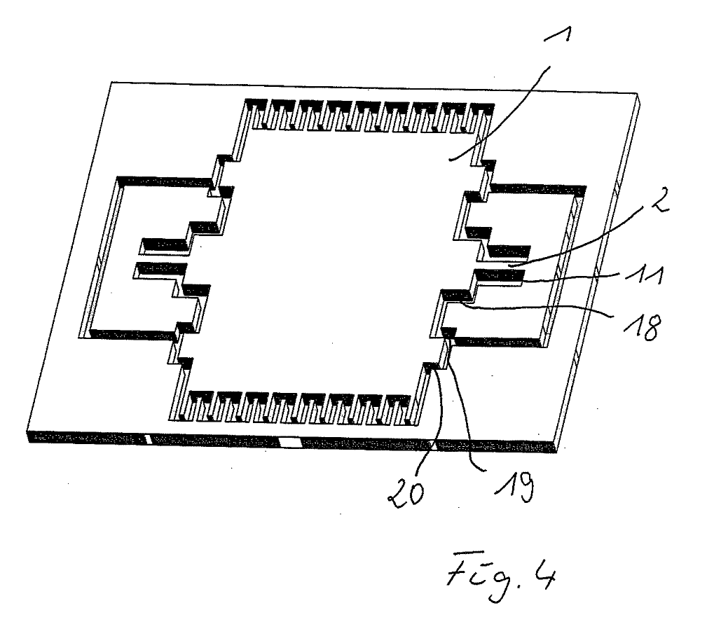

This should be looked at more closely in the description of an embodiment in accordance with FIG. 4.

An armature can also be formed at a spring by the grooves formed by structuring of a substrate, with the spring opening into said armature in the direction of the frame part and with said armature quasi forming a support/clamping of a spring. Such an armature is then electrically insulated with respect to the frame part, as has already been initially addressed.

Since this armature is connected to the deflectable element via the spring, the same electrical voltage potential can also be applied there.

This is not present in a self-explanatory manner with an additional armature if it is arranged at the frame part. It can, however, be connected via an additional contact to the same electrical voltage potential as the deflectable element so that electrical short-circuits can be avoided.

Abutments can be formed by grooves formed at a spacing from the longitudinal axis and having an alignment deviating from this which have a sufficient strength when their path limitation function is required.

The micromechanical components should preferably be made at least approximately symmetrically with respect to the longitudinal axis of springs.

Substrates can be used for micromechanical components which are not electrically conductive and which are regionally electrically conductive by means of doping or coating with an electrically conductive material. However, electrically conductive substrates can also be used for the manufacture of components. This can be silicon, for example.

The invention should be explained in more detail in the following with reference to examples.

There are shown:

FIG. 1: an example of a micromechanical component in accordance with the prior art;

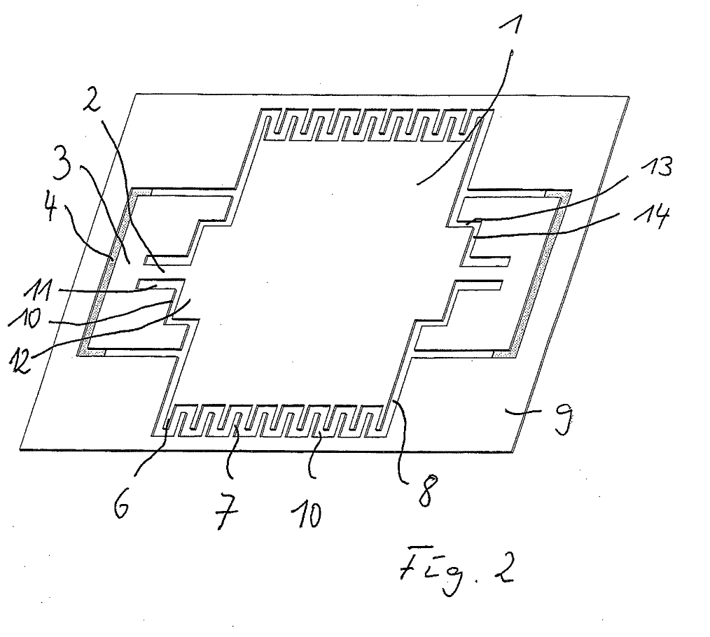

FIG. 2: an example of a micromechanical component in accordance with the invention;

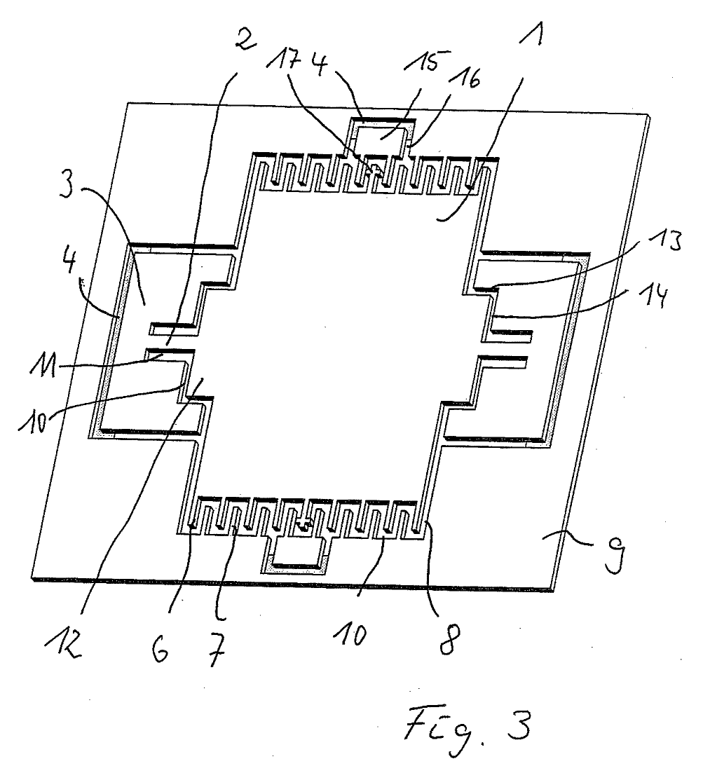

FIG. 3: an example of a micromechanical component in accordance with the invention with an additional armature and abutment in the region of electrode fingers; and

FIG. 4: an example in accordance with the invention with a plurality of path limitation elements arranged at different spacings from the longitudinal axis of springs.

In the embodiment of a micromechanical component shown in FIG. 1, a deflectable element 1 is held by means of the two springs 2 as a suspension. The parts are made from monocrystalline silicon, formed as a layer. An embodiment is preferably used for the manufacture having so-called bonded silicon on insulator (BSOI) in the form of a wafer. In this connection, the upper layer visible in the illustration is made of silicon which is separated from a lower silicon layer by a silicon oxide layer. The lower silicon layer can be removed except for the region of the frame part 9. The lower silicon layer on the frame part 9 increases the mechanical strength.

The deflectable element 1 is connected to the springs 2. The springs 2 merge into an armature 3. The armature 3 is electrically insulated with respect to the frame part 9 by the insulation 4, but is mechanically connected thereto. A procedure can be followed in manufacture such that a groove is etched into an upper silicon layer. The etching takes place selectively and is stopped at a buried oxide 4. The buried oxide forms an intermediate layer between an upper layer which can be used for the mechanical elements and a lower layer.

A groove can be filled with an oxide layer. In this connection, this groove should not be guided through the total thickness and formed as a groove-like recess. The oxide fills said groove to the extent that no electrically conductive connection is present between the deflectable element 1, the spring 2 and the armature 3 with the frame part 9.

In a form not shown, the deflectable element 1 and the frame part 9 are contacted electrically in a separate manner and are connected to an electrical power source. For instance, positive electrical voltage can e.g. be applied to the deflectable element 1 and negative electrical voltage can be applied to the frame part, or also vice versa.

Electrode fingers 6 and 7 are formed at the deflectable element 1 and the frame part 9 at two oppositely disposed sides of the component by a groove 5 made in meander-like form. The electrode fingers 6 and 7 therefore have the respective electrical voltage potential, which can be utilized for the drive for the deflection of the element 1.

With total symmetry and while neglecting all external forces and thermally induced movements (Brownian molecular movement) of a component, the electrical voltage difference can theoretically be as large as desired without a resulting electrostatic force being able to pull the electrode fingers 6 and 7 together and without them coming into touching contact and a short-circuit occurring. A complete symmetry is, however, actually not achievable due to manufacturing circumstances so that the deflectable element 1 is deflected ever further as the electrical voltage difference increases. A corresponding restoring force is applied by the springs 2 by deformation. With electrostatic forces which have a high effect and which exceed the mechanical restoring force of springs 2, the electrode fingers 6 and 7 can be accelerated toward one another in the lateral direction and can impact one another. The electrode fingers 6 and 7 can break and be damaged or destroyed in the process. An electrical short-circuit and/or electrical flashovers can moreover occur which also result in further destruction or damage to electrical or electronic components.

As a result of adhesion forces, electrode fingers 6 and 7 can also adhere to one another without a voltage potential difference or even be welded together and the components can thereby also lose its function.

These disadvantageous effects can, however, also be caused by other forces. By a corresponding acceleration of the component on impact or on another abrupt movement, the forces resulting therefrom can likewise exceed the spring forces and this can result in a movement or deflection of the deflectable element 1 with further parts or elements formed thereon. With solutions such as are known from the prior art, it cannot be avoided that short-circuits occur as a consequence of movements or deflections of the deflectable element 1 or also only parts thereof.

This is, however, achievable with the invention.

FIG. 2 thus shows an example which is configured in a similar manner to the embodiment in accordance with FIG. 1 so that a corresponding explanation is partly omitted an only aspects relating to the invention should be taken into account in more detail.

It becomes clear that further grooves 13 and 14 are formed in addition to the grooves 5, 8, 10 and 11. An abutment 12 is formed in the respective corner region at the deflectable element 1 by their arrangement and alignment. The clearance of the grooves 13 and 14 is smaller than the clearance dimensions of the other grooves 5, 8, 10 and 11. The end faces separated by the grooves 13 and 14 thereby abut one another on a movement/deflection of the deflectable element 1 exceeding a certain degree, whereby a critical approaching of other parts or regions which are at different electrical voltage potentials is avoided. This applies in particular to the avoidance of a contact of electrode fingers 6 and 7.

Such grooves 13 and 14 forming a path limitation element can be arranged mutually opposite one another at a respective spring 2 even though the reference numerals are only marked at two such grooves 13 and 14.

The configuration of the grooves 13 and 14, and thereby also the configuration of the abutments 12, can take place such that damage or destruction is also avoided at higher accelerations and forces resulting therefrom. Adhesion (sticking) can also be avoided.

The dimensioning of the abutment 12 and of the grooves 13 and 14 should be selected such that the path limitation is provided on a pivoting of the deflectable element 1 with a maximum amplitude. With a lateral deflection at right angles to the component plane, the thickness in the region of the abutment 12 should be larger than the maximum deflection amplitude. The remaining gap (e.g. at electrode fingers) should also be sufficiently large after a “docking” of contact surfaces to avoid an electrical flashover. In this connection, the respective electrical voltage should be taken into account for the respective required gap width.

In the event that a deep silicon etching process known per se and starting from a surface is used for the structuring and open grooves are formed in the process whose width and a clearance only differ slightly from one another, the extent of a deflectable element 1 perpendicular to springs 2 in the component plane can be large in relation to the extent in the direction of the springs 2. A pivoting of a deflectable element 1 around an axis perpendicular to the component plane and through its center can thereby have the result that the electrode fingers 6 and 7 nevertheless approach one another too much or even contact one another.

This can be countered by an embodiment of the invention in accordance with the example shown in FIG. 3.

In this connection, at least one abutment 17 (there are two abutments 17 in FIG. 3) is present at an electrode finger 6 which is formed at the deflectable element 1. Such a finger can then have the shape of a cross. This finger with the abutment 17 is encompassed on two sides by two fingers of an additional armature 15. The additional armature 15 is connected to the frame part 9, is held by it and insulated electrically with respect to it. The insulation 4 can again, as already explained, have been configured, in an analogous manner to that at the armature 3 in accordance with FIG. 2, by filling a groove 16 with electrically insulating material. The additional armature 15 should advantageously be connected to the same electrical voltage potential as the deflectable element 1.

If the deflectable element 1 is moved parallel to the longitudinal axes of the springs 2, at an angle inclined obliquely thereto or orthogonally to the longitudinal axes of the springs 2, the finger with abutment 17 abuts the additional armature 15 since the respective clearances are smaller than the width or clearances of at least the other grooves 5, 8, 10 and 11.

The parts and fingers of the abutment 17 and the additional armature 15 can also have larger dimensions than electrode fingers 6 and 7.

The disadvantages already mentioned a plurality of times can thus be avoided.

In some cases, a path limitation only by such abutments 17 and additional armatures 15 can be sufficient to be able to achieve the desired effect. However, the embodiment with additional grooves 13 and 14 as further path limitation elements shown in FIG. 4 is more robust and even more reliable.

The example shown in FIG. 4 can e.g. be manufactured from a substrate with a larger thickness than the preceding described examples. The grooves 11 which are formed around the springs 2 are wider and have a larger clearance than the grooves 18, 19 and 20 with their abutments as path limitation elements. In this connection, the grooves 18 to 20 are each formed smaller with a smaller clearance stepwise as the spacing from the longitudinal axis of the springs 2 increases.

With an externally acting acceleration having a vector perpendicular to the springs 2 in the component plane, the abutment 20 formed by the groves thus acts first and limits the path which can be covered by a movement of the deflectable element 1.

If, in contrast, the deflectable element 1 oscillates and is pivoted around the longitudinal axis of the springs 2, the abutment 20 formed by grooves will be without effect since a mechanical contact in this region is no longer possible with such a deflection of the deflectable element 1 with a large amplitude. This can, however, be achieved with the abutments 19 and 18 formed by grooves and arranged more closely to the rotation axis which is predetermined by the springs 2 and as a rule coincides with their longitudinal axis.

The respective configuration of grooves for path limitation elements with their selected clearances while taking account of their arrangement at the component can be adapted for the application, that is for the use with functionality of the component.

Grooves around springs should always be wider than grooves at path limitation elements. The thin and fragile springs are then not exposed to any impact strain on occurring accelerations (e.g. on a shock or internally electrostatically) since no mechanical contact can occur. The mechanical reliability can thus be increased.

The gap width should also take into account that this is also secured on a twisting of springs since spring cross-sections can be prismatic and thus laterally wider at some points.

1. A micromechanical component wherein a deflectable element is held at a frame part by at least one spring, the deflectable element with said at least one spring is mechanically and electrically separated from the frame part by configured grooves and electrical insulation; the frame part and the deflectable element with said at least one spring are adapted to have an electrical voltage applied therebetween, path limitation elements are formed between regions which are at least one of adapted to be at the same electrical voltage potential and adapted to exhibit a negligible electrical current flow with touching contacting of such regions.

2. A component in accordance with claim 1 wherein said path limitation elements have first grooves, second grooves are provided between the deflectable element and the frame part, and the clearance of the first grooves is smaller than the clearance of the second grooves.

3. A component in accordance with claim 2 further including mutually engaging electrode fingers at outer end faces of the deflectable element and, complementary thereto, at the frame part the mutually engaging electrode fingers separated from one another by second grooves.

4. A component in accordance with claim 3 wherein said second grooves separating said electrode fingers from one another have a larger clearance than said first grooves.

5. A component in accordance with claim 1 further including an armature attached to the frame part, is electrically insulated with respect to the frame part and forming a path limitation element with an abutment at the deflectable element.

6. A component in accordance with claim 5 wherein a smaller clearance is provided between the additional armature and the abutment in at least one axial direction than the clearance of said second grooves.

7. A component in accordance with claim 1 wherein said first grooves are aligned at an obliquely inclined angle with respect to the longitudinal axis of said at least one spring.

8. A component in accordance with claim 1 wherein regions touching common path limitation elements exhibit electrically high resistance between them.

9. A component in accordance with claim 8 wherein said high resistance connection is formed by at least one of locally configured layers from electrically non-conductive material and locally configured layers from a material having a high electrical resistance.

10. A component in accordance with claim 1 wherein grooves forming path limitation elements have a stepwise reducing clearance as the spacing from said at least one spring increases.

11. A component in accordance with claim 1 wherein said at least one spring opens into an armature in the direction of the frame part, and further comprising insulation for electrically insulating said armature with respect to the frame part.

12. A component in accordance with claim 5 including insulation for electrically insulating the armature with respect to the frame part.

13. A component in accordance with claim 11 comprising an open groove forming the insulation.

14. A component in accordance with claim 11 wherein the insulation comprises a groove at least partly filled with an electrically insulating material positioned between the armature and the frame part.

15. A component in accordance with claim 5 wherein the additional armature is connected to the electrical voltage potential of the deflectable element.

16. A component in accordance with claim 1 wherein an abutment is formed with grooves of a path limitation element at the deflectable element.

17. A component in accordance with claim 3 wherein path limitation elements are arranged in the region of at least one of the at least one spring and the electrode fingers.

18. A component in accordance with made claim 1 which is symmetrical with respect to the longitudinal axis of the at least one spring.

19. A component in accordance with claim 2 further including an armature attached to the frame part, electrically insulated with respect to the frame part and forming a path limitation element with an abutment at the deflectable element.

20. A component in accordance with claim 3 further including an armature attached to the frame part, electrically insulated with respect to the frame part and forming a path limitation element with an abutment at the deflectable element.

21. A component in accordance with claim 4 further including an armature attached to the frame part, electrically insulated with respect to the frame part and forming a path limitation element with an abutment at the deflectable element.
